(19) United States
(12) Patent Application Publication
(10) Pub. No.: US 2004/0064075 A1
(43) Pub. Date: Apr. 1, 2004

(54) Massage device

(75) Inventors: Wendy Robbins, Pine Mountain, CA (US); Jorli McLain, Pine Mountain, CA (US)

Correspondence Address: DONALD J. LENKSZUS, PO BOX 3064, CAREFREE, AZ, 85377, US

(73) Assignee: EVERYTHING FOR LOVE, INC., PINE MOUNTAIN, CA

(21) Appl. No.: 10/603,060

(22) Filed: Jun. 23, 2003

Related U.S. Application Data
(60) Provisional application No. 60/390,614, filed on Jun. 22, 2002.

(51) Int. Cl. A61H 7/00

(52) U.S. Cl. 601/107; 601/135; 601/137

(57) ABSTRACT

The invention is directed to a massage device that includes a plurality of flexible fingers that are splayed outward. Each finger is resilient and provides stimulation pressure to a body area or part.

### RELATED APPLICATIONS

This application is related to our prior application Ser. No. 09/621,952 filed Jul. 21, 2000 and titled Massage Device. The disclosure of our prior application is incorporated herein by reference.

Priority is claimed based on Provisional Application No. 60/390,614 filed Jun. 22, 2002.

### FIELD OF THE INVENTION

The present invention relates to massage devices, in general and to body massage devices, in particular.

### BACKGROUND OF THE INVENTION

Our prior U.S. Pat. No. 6,450,980 titled “Massage Device With Flexible Fingers,” issued on Sep. 17, 2002 is directed to a head massage device that provided a significant improvement over U.S. Pat. No. 6,309,365 issued on Oct. 30, 2001 and titled “Head Massaging Device.”

Our prior patent is directed to a head massage product that has been commercially successful because of the unique stimulating sensations that it provides.

We have determined that it would be desirable to have a massage product that would provide similar stimulating sensations to the body and limbs.

### SUMMARY OF THE INVENTION

A massage device in accordance with the principles of the invention includes a handle, and a plurality of flexible, elongated members protruding from the handle. The plurality of flexible, extended members extend generally laterally outward from the handle and then downward. The resultant configuration of the fingers is a rake like configuration.

The handle of the massage device in certain embodiments includes massage surfaces that include one or more protrusions.

In one embodiment of the invention the handle is a hollow tubular member that is closed at one end by an end cap. The end cap includes an aperture through which one end of each of the flexible members extends into the hollow tubular member. Each of the ends of the flexible members extending into the handle is affixed into the handle by fastening means disposed in the handle. In one embodiment of the invention, an adhesive filler is utilized to permanently attach the flexible members to the handle.

In accordance with one embodiment of the invention, the flexible members are formed from copper wire. The handle in one embodiment is formed from a copper tube. In another embodiment of the invention, the handle is formed of a non-metallic material such as plastic or resin material, wood or bamboo or other non-metallic material.

A massaging device in accordance with the principles of the invention includes a plurality of resilient fingers each having a first portion extending outward from a central area and each having a second portion extending downward from the first portion and terminating in a free end. The free ends of the fingers are used to contact and apply stimulating sensations to a body portion.

In accordance with one aspect of the invention, each finger of the plurality of fingers is resilient so that each corresponding free end may move to conform to the surface of the body portion contacted with the free ends.

In one embodiment of the invention, each free end terminates in a smooth and/or rounded portion In addition, in the one embodiment, each finger is wire, and preferably copper wire.

Further in accordance with one aspect of the invention, each finger comprises an end portion extending from the first portion. A handle for gripping and manipulating the massaging device is provided. The end portion of each of the fingers terminates in and is secured within the handle. The handle comprises a common area that in one embodiment is a tubular hollow portion. Each finger end portion extends into and is affixed to said tubular hollow portion.

In one embodiment of the invention, the handle comprises an insert, that includes the tubular hollow portion. In another embodiment, the insert is used to receive various additional components to enhance the massage experience.

In an embodiment of the invention, the handle comprises a metallic portion and/or a non-metallic portion.

In accordance with another aspect of the invention, the device may carry one or more vibrators.

In a further embodiment of the invention, a massaging device comprises a vibrator, and a plurality of resilient and pliable fingers coupled to the vibrator. Each finger has a free end and an opposite end. The opposite ends are coupled to the vibrator. The finger free ends are used to apply pressure and couple vibrations from the vibrator to a body portion.

In accordance with one aspect of the invention the massage device includes a handle and the vibrator is contained in the handle.

In accordance with the principles of the invention, a massaging device may include a first plurality of resilient fingers each having one portion extending substantially radially outward from a central axis and in substantially the same plane. Each finger has another portion extending downward from said one portion and terminating in a free end. The another portions of the first plurality of fingers define a plane. The free ends of the fingers of the first plurality of fingers and of the second plurality of fingers are used to contact and apply stimulating sensations to a body portion.

In yet another massaging device a handle has a plurality of resilient fingers each having a first one portion extending outward from said handle and each having a second portion extending downward from the one portion and terminating in a free end. The first portions are positioned to be substantially in one plane. The free ends of the fingers lie in substantially a second plane.

In certain embodiments of the invention the device comprises a material that changes color depending upon certain conditions at the surface of the handle.

In another embodiment of the invention, the device emits light. In certain specific embodiments, the device comprises a light emitting material.

In yet another embodiment of the invention, the fingers are arranged in a unitary configuration that approximates the shape of a hand that carries a plurality of projections thereon that are utilized to provide massage sensations. Each of the projections may include a small vibrator unit disposed therein.

### BRIEF DESCRIPTION OF THE DRAWINGS

The invention will be better understood from a reading of the following detailed description of several embodiments of the invention in conjunction with the drawing figures, in which like reference designations are used to identify like elements, and in which:

FIG. 1 is a side elevation view of a massage device according to the present invention;

FIG. 2 is a top view of the device of FIG. 1;

FIG. 3 is a right hand end view of the device of FIG. 1;

FIG. 4 is a side view of a second massage device;

FIG. 5 is an top view of the massage device of FIG. 4;

FIG. 6 is a right hand end view of the device of FIG. 4;

FIG. 7 is a top view of a third massage device in accordance with the principles of the invention;

FIG. 8 is a side view of the massage device of FIG. 7;

FIGS. 9 and 10 are top and bottom views of a fourth massage device in accordance with the principles of the invention;

FIGS. 11 and 12 are top and side views of a fifth massage device in accordance with the principles of the invention;

FIGS. 13 and 14 are perspective side and bottom views of a sixth massage device in accordance with the principles of the invention;

FIGS. 15, 16, 17 18 and 19 are end perspective, top perspective, top, side, and bottom perspective views of a seventh massage device in accordance with the principles of the invention;

FIGS. 20 and 21 are side and bottom views of an eighth massage device in accordance with the principles of the invention;

FIGS. 22 through 25 show another embodiment of the invention; and

FIGS. 26 through 29 show yet another embodiment of the invention.

### DETAILED DESCRIPTION

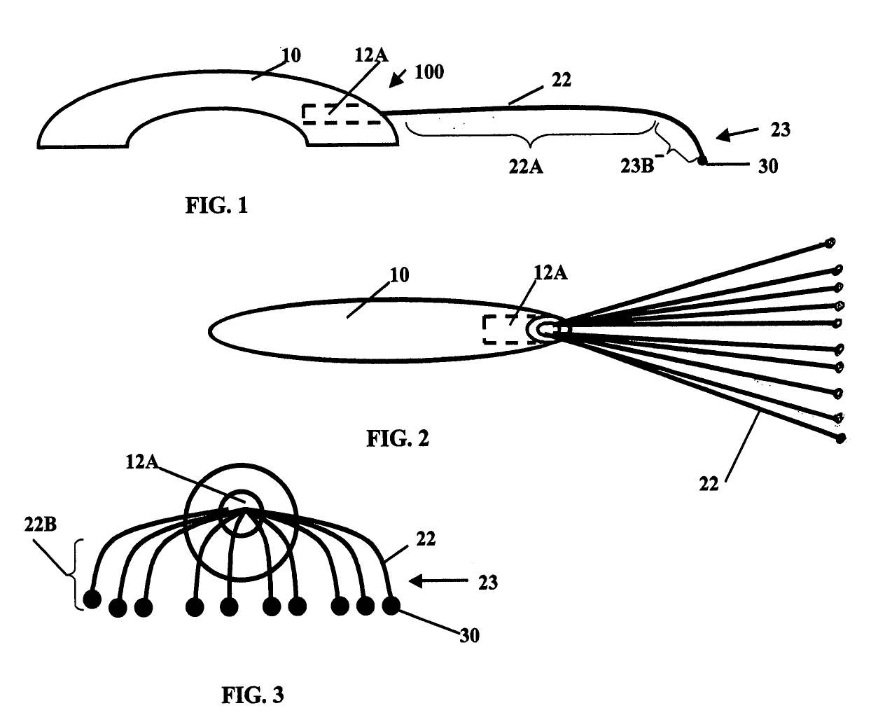

A first massage device 100 is shown in FIG. 1, and includes a handle 10 and a plurality of flexible, elongated members or fingers 22 protruding from the handle 10. Each of the plurality of flexible, elongated members or fingers 22 are bendable, and may be composed, for example, of copper material or other metal or metal alloy.

The flexible, metallic fingers 22 are preferably sufficiently stiff as to retain their position and shape. They are somewhat resilient, inasmuch as they will return to their initial positions after application of a force thereto less than a bending force. However, upon application of a force sufficient to cause bending, once bent by a user so as to be moved to another position or formed into another shape under a bending force, the flexible, metallic prongs or fingers 22 will stay in that shape.

The free end or terminus 23 of each of the flexible, metallic prongs or fingers 22 is rounded over. More specifically, the terminus 23 of each finger 22 has a covering 30. Covering 30 is preferably a soft, resilient plastic coating, to protect the skin against injury or damage. Covering 30 can be applied to the trips by dipping in liquid plastic material, for example. It is also contemplated as being within the scope of the present invention that each of the coverings 30 could be a pre-molded piece which is slid over respective ones of the tips of the fingers 22 and secured thereon frictionally or by adhesive. All such variations are contemplated as being within the scope of the present invention.

It is contemplated as being within the scope of the present invention that each of the plurality of flexible, elongate members or fingers 22 may be composed of other suitable materials for use as a massage device, for example, flexible plastic or rubber material. All such variations are contemplated as being within the scope of the present invention.

Handle 10 is of generally arcuate shape and includes an aperture and a hollow body portion 12a. An end portion of each finger 22 extends into body portion 12a and is fastened within the body 10.

Each finger 22 has a first portion that 22a that extends outward from handle 10 and a shorter second portion 22b that extends substantially downward from first portion 22a. The first portions of fingers 22 lie in approximately a first plane A. The free ends of each finger terminate in substantially the same second plane B. The second plane B is approximately parallel to the first plane A.

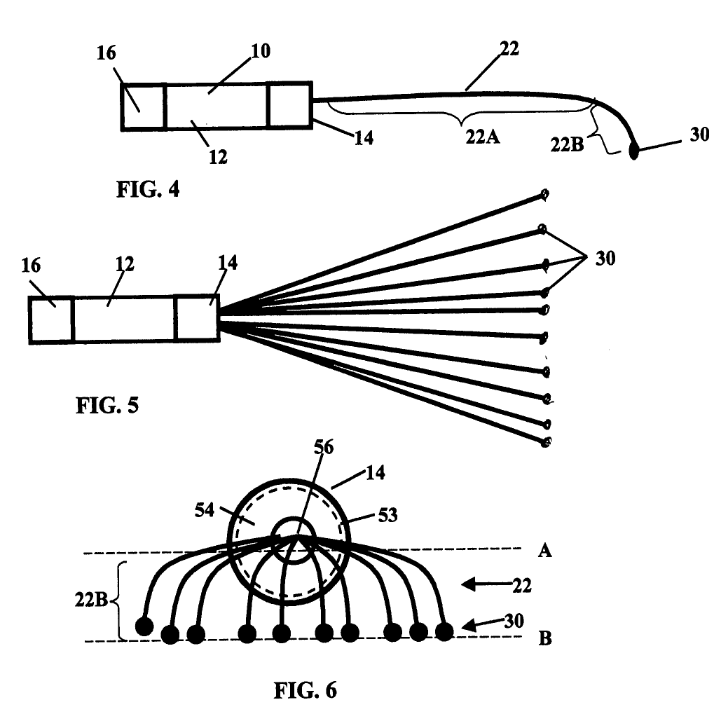

FIGS. 4, 5, and 6 show a second embodiment in which the handle 100 is of generally tubular configuration, Handle 100 includes an elongate tubular portion 12 and first and second end caps 14, 16. End cap 16 has an aperture 56 through which fingers 22 extend into tubular portion 12 where the end portions of fingers 22 are fastened to the tubular portion 12.

When end cap 14 is assembled onto tubular body portion 12, the interior of tubular wall 53 is affixed to the exterior surface 13 of tubular body portion 12. The affixation may be provided by the use of any of a number of conventional means and methods of affixation, including, but not limited to the use of adhesive, mating screw threads, soldering, welding, brazing, and pressure fit.

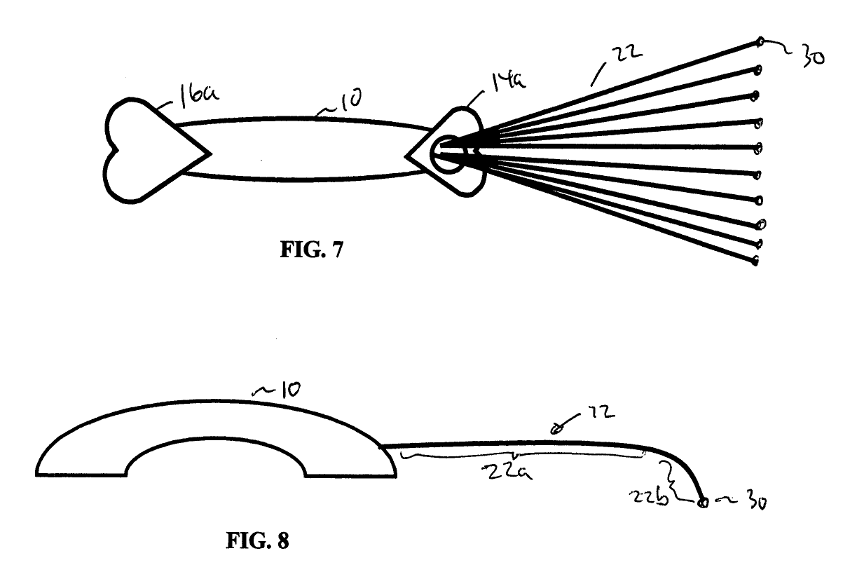

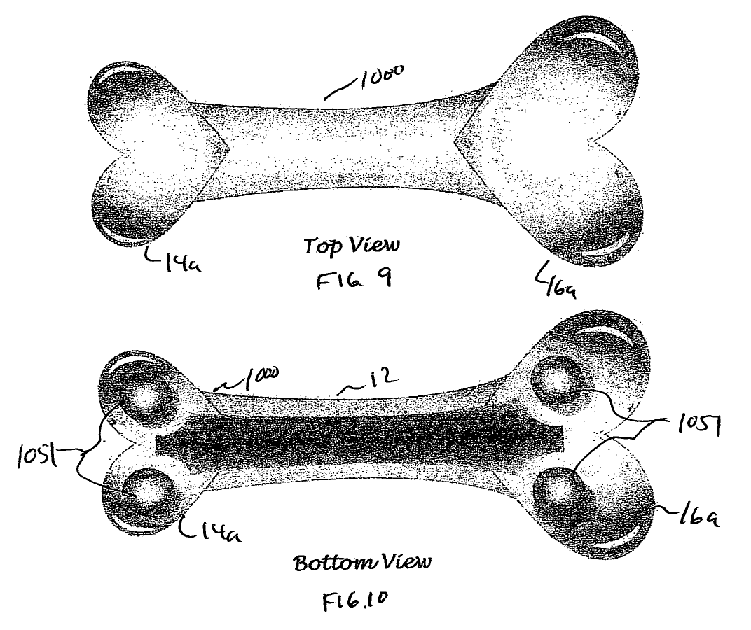

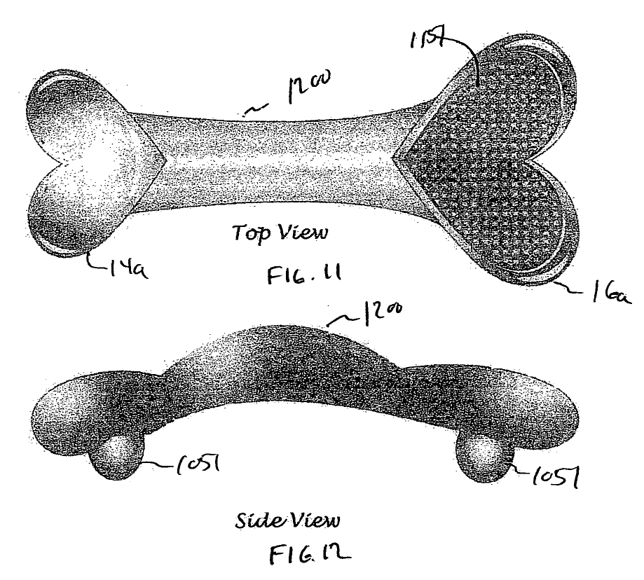

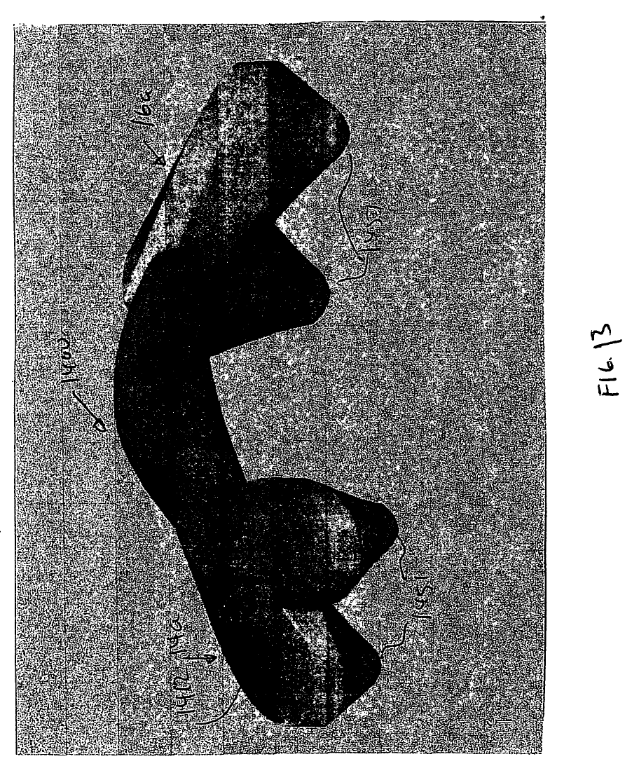

FIGS. 7 and 8 show a third embodiment of the invention that is similar to the embodiment shown in FIG. 1. Each end 14a, 16a of handle 10 terminates in rounded portions that are configured 5 as heart shaped portions

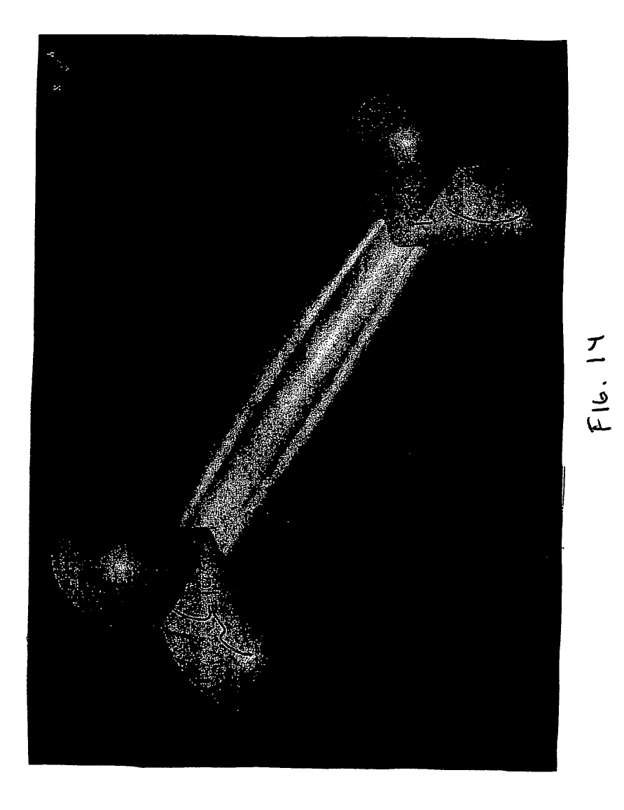

FIGS. 9 and 10 show a massage device 1000 or a massage device handle that includes rounded over protrusions 1051 on the bottom of each end portion 14a, 14b. Protrusions 1051 are used to provide massage points such that by pressing device 1000 against the area to be massaged or by tilting the device 1000 while pressing against the area to be massaged.

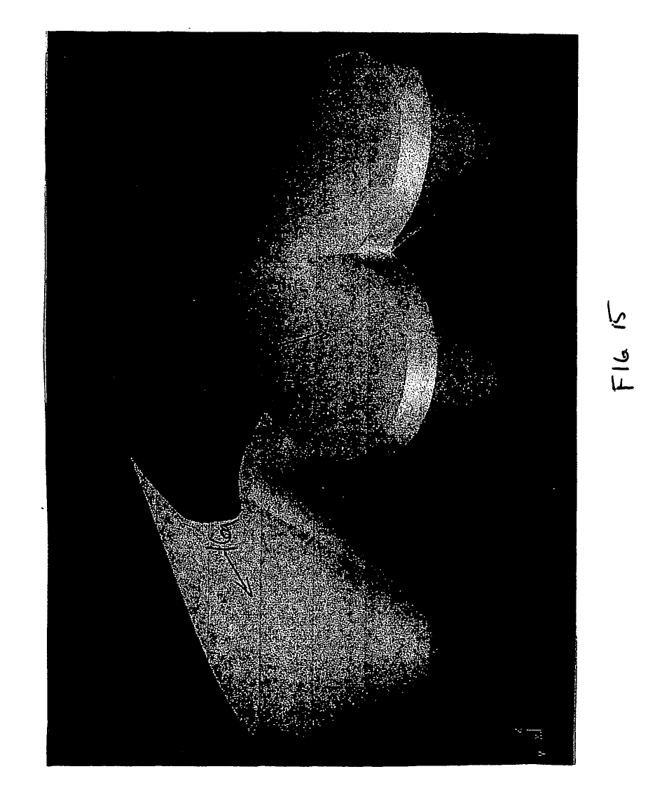

FIGS. 11 and 12 shows a massage device 1200 or massage device handle that includes rounded over protrusions 1051 on the bottom of each end portion 14a 14b. In addition, end 16a includes on its upper surface another massage area in the form of a plurality of smaller protusions that may be in the shape of pyramids, truncated pyramids, rounded pyramids or knobs of a variety of shapes.

FIGS. 13 and 14 show a massage device or massage device handle 1400. Handle 1400 includes rounded over protrusions 1451 for providing massage action. In addition, a socket is provided to receive fingers 22 or other massage or stimulating implements.

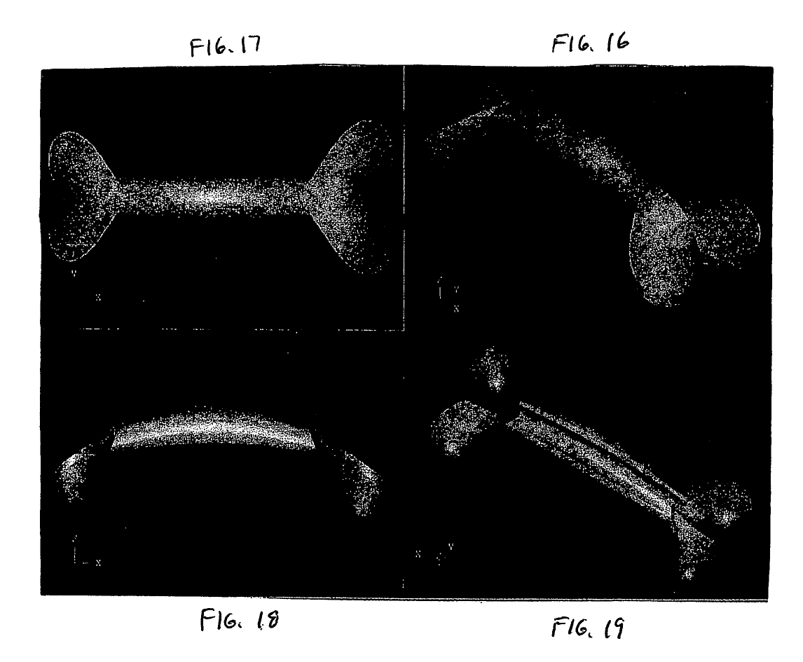

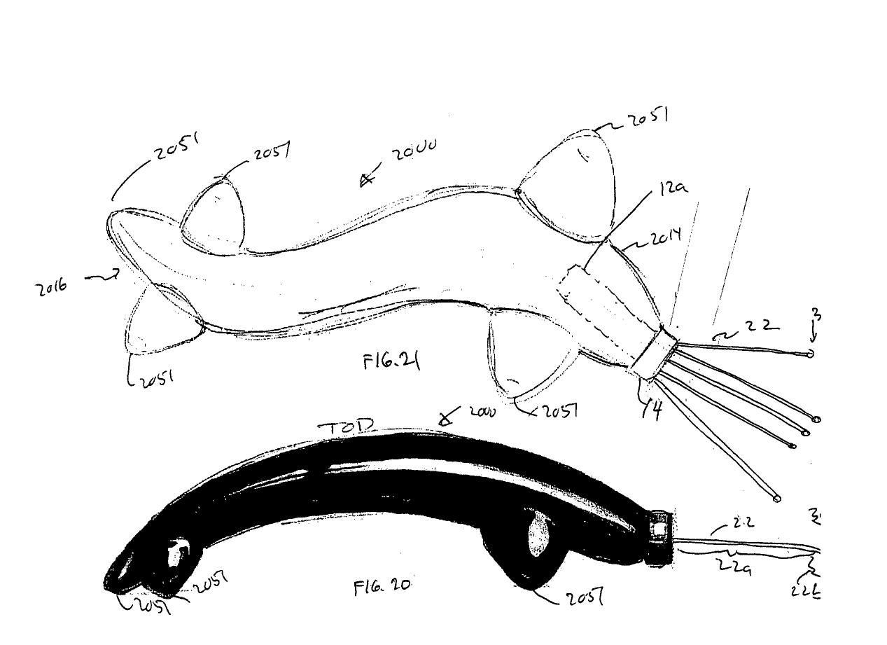

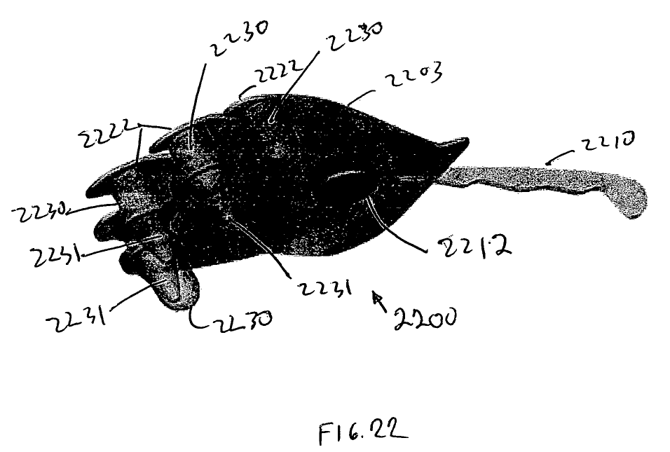

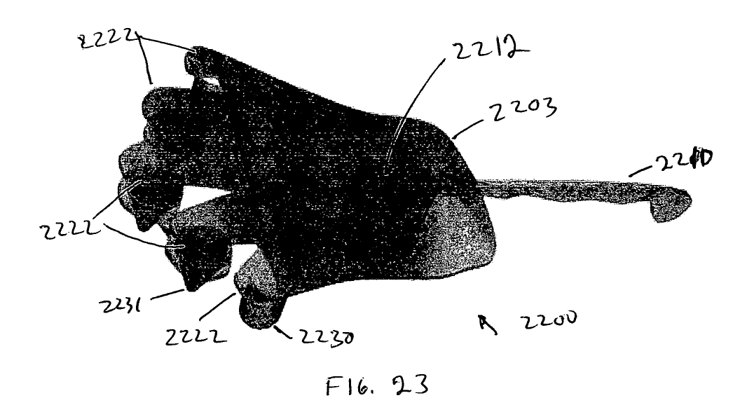

FIGS. 15 through 19 illustrate a further massage device 1600 that is substantially similar to massage device 1400 with the exception that the socket 1451 is not provided.

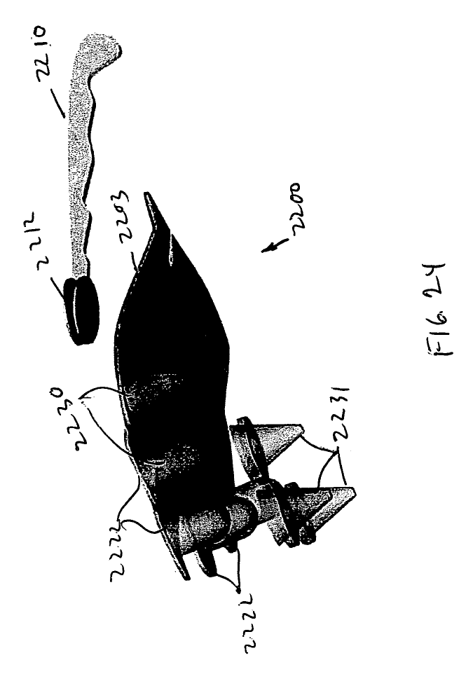

FIGS. 20 and 21 show a further massage device 2000 that includes massage protrusions 2051 at each end 2014, 2016. A plurality of massage fingers 22 extends from end 2014. A cavity 12a is provided which receives one end of each of fingers 22. A metal end cap 14 is provided. End cap 14 includes an aperture 56 through which fingers 22 extend into cavity 12a.

Any of the various embodiments may include a vibrator unit internal to the device or external thereto to enhance the massage effects.

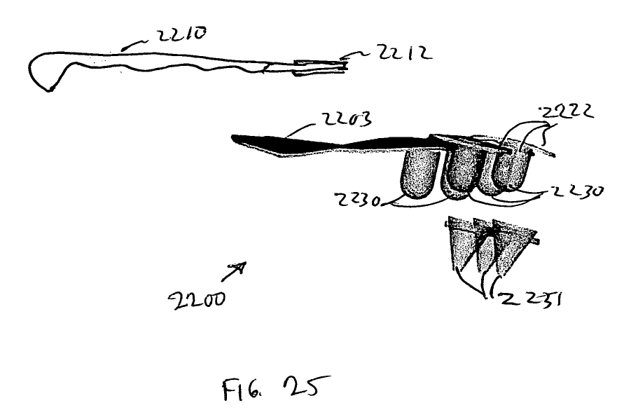

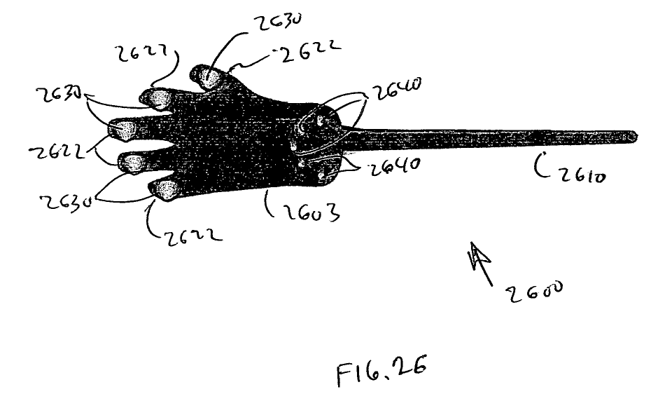

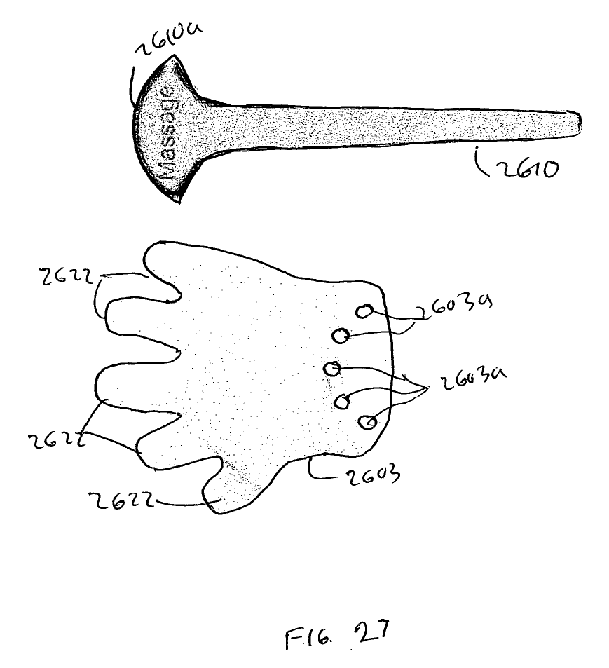

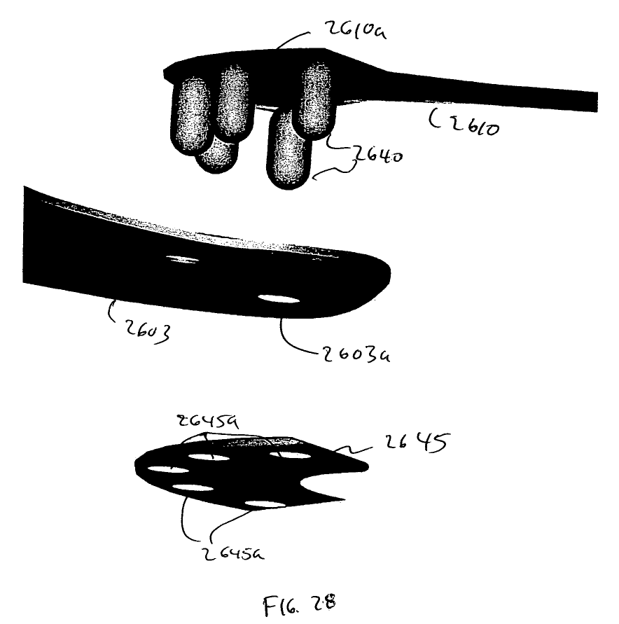

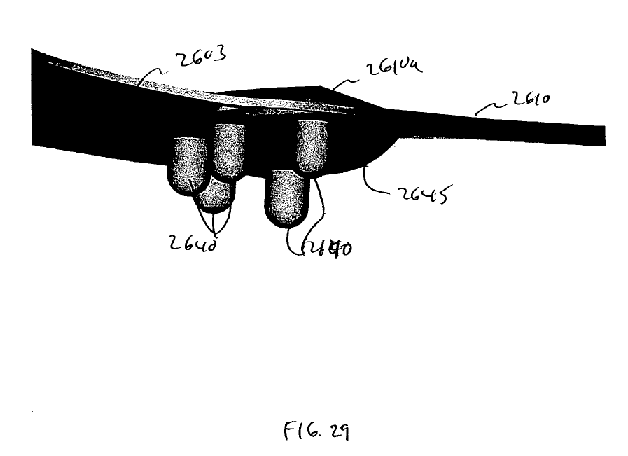

FIGS. 22 through 25 show another embodiment 2200 of the invention in which a handle 2210 is removably connected to a member 2203 that has fingers 2222 extending generally laterally away from the handle 2210. Each finger has a downward extending protrusion 2230 is used to provide massage like stimulation by manipulation of the device 2200. Each protusion 2230 may include a pointed member 2231 that, in the illustrative embodiment, is carried on a corresponding protusion. Handle 2210 includes a member 2212 that affixes to member 2203. When assembled with handle 2210, the device 2200 may be used to stimulate body areas such as the back or the extremities. Handle 2210 may be removed and device 2200 may be manipulated by placing fingers onto member 2203 such that each finger is disposed above a corresonding one of fingers 2222 to provide for a more controlled sensation. Each of fingers 2230 may have a vibrator unit contained therein for a more stimulating massage. In addition, one or more of the components 2210, 2203, 2230 or 2231 may be of a material that either changes color under predetermined conditions such as surface temperature or may emit light. Alternatively, a single vibrator unit may be carried on device 2200 in a different location.

FIGS. 26 through 29 show yet another embodiment of the invention in which a handle 2610 has extending therefrom fingers 2222 that are carried by member 2603. Each finger 2622 has a downwardly extending protrusion 2630. Handle 2610 is removable from member 2603. Handle 2610 includes an end portion 2610a that carries protrusions 2640. Protrusions 2640 extend through corresponding apertures 2603a carried by member 2603 into and through corresponding apertures 2645a carried by plate 2645. Protrusions 2640 are deformable such that the when inserted and seated into apertures 2603a and 2645a, handle 2610, member 2603 and plate 2645 lockingly engaged together. As with device 2200, device 2600 may be used with or without handle 2610. One or more of the components of device 2600 may be of a material that changes color with temperature and/or may emit light. As with the other devices in accordance with the invention, one or more vibrators may be carried on or coupled to device 2600.

It will be appreciated by those skilled in the art that devices 2200 and 2600 may be constructed of plastic material that is resilient. In addition, depressions may be provided on the top surface of fingers 2622 or 2222 with the depressions being proximate the corresponding protrusions 2630 or 2230 with the depressions being disposed to that the finger tips of a user may be received therein.

Member 2603 has the approximate shape of a hand. Protrusions 2630 are at the fingertips. When handle 2610 is assembled to member 2603, protrusions 2640 are in the area of the base of the palm area of member 2603.

It will be appreciated by those skilled in the art that the fingers of the various massage device embodiments shown may be arranged such that the ends of the fingers define a curve or arc to enhance contact with body areas or parts.

Although the invention has been described in terms of several embodiments, it is not intended to limit the scope of the invention to the particular embodiments shown. It will be appreciated by those skilled in the art that various changes and modifications may be made to the various embodiments without departing from the spirit or scope of the invention. It is intended that the invention be limited only by the claims appended hereto.

What is claimed is:

1. A massage device comprising:
a handle;
a plurality of flexible fingers, each of said fingers having one end affixed in said handle, each of said fingers having a first portion extending laterally and radially outward from a first end of said handle, and each of said flexible fingers having a second portion extending downward from its corresponding first portion, each of said second portions terminating in a free end, the free ends of said fingers being used to contact and apply stimulating sensations to a body portion.

2. A massage device in accordance with claim 1, wherein:
said handle comprises a tubular member.

3. A massage device in accordance with claim 2, wherein:
said plurality of flexible fingers define an curve.

4. A massage device in accordance with claim 1, wherein:
said handle comprises a non-metallic material.

5. A massage device in accordance with claim 1, wherein:
each of said fingers is resilient such that it corresponding free end may move to conform to the surface of the body portion contacted with the free ends.

6. A massage device in accordance with claim 5, wherein:
each of said fingers comprises copper wire.

7. A massage device in accordance with claim 5, wherein:
each said free end terminates in a smooth portion.

8. A massage device in accordance with claim 5, wherein:
each said freed end terminates in a rounded portion.

9. A massage device in accordance with claim 1, wherein:
said handle has a cavity formed therein; and
each of said flexible fingers has a third portion extending from said first portion into said cavity, and each said third portion is affixed to said handle in said cavity.

10. A massage device in accordance with claim 2, comprising:
a cap disposed on said handle at said first end, said cap having an aperture through which each of said fingers extends.

11. A massage device in accordance with claim 1, comprising:
an insert extending into said handle at said first end, said insert being coupled to x said fingers in said handle.

12. A massage device in accordance with claim 11, wherein:
said handle comprises a cavity; and
said insert is secured in said cavity.

13. A massage device in accordance with claim 12, wherein:
each of said flexible fingers has a third portion extending from said first portion into said insert; and
each said third portion being affixed within said insert.

14. A massage device in accordance with claim 11, wherein:
said insert and said fingers are removable as a unitary piece from said handle.

15. A massage device in accordance with claim 3, wherein:
the free ends of each of said flexible fingers terminates

16. A massage device in accordance with claim 11, wherein:
said insert comprises a vibrator.

17. A device in accordance with claim 1, wherein:
each of said fingers first portions is disposed in substantially a first plane; and
each of said fingers second portions is disposed in substantially a second plane that intersects said first plane.

18. A device in accordance with claim 1, wherein:
each of said finger first portions is disposed in substantially a first plane; and
said finger free ends all lie in substantially a third plane.

19. A device in accordance with claim 1, wherein:
said handle comprises a material that changes color depending upon certain conditions at the surface of said handle.

20. A device in accordance with claim 1, wherein:
said handle emits light.

21. A device in accordance with claim 1, wherein:
said handle comprises light emitting material.

22. A device for providing stimulation sensations to a body portion, comprising:
a handle for gripping and manipulating said device;
a plurality of fingers extending from one end of said handle, each of said fingers having a free end and an opposite end; and
a vibrator disposed within said handle and coupled to said plurality of fingers;
each of said fingers being resilient, each of said fingers having a first portion extending from said handle and each having a second portion terminating in a corresponding free end, each said finger second portion being contiguous to and extending in a direction different from said first portion;
whereby said free ends of said fingers are used to apply pressure to and to couple vibrations from said vibrator to a body portion.

23. A device in accordance with claim 22, wherein:
each of said fingers first portions is disposed in substantially a first plane; and
each of said fingers second portions is disposed in substantially a second plane that intersects said first plane.

24. A device in accordance with claim 22, wherein:
each of said finger first portions is disposed in substantially a first plane; and
said finger free ends all lie in substantially a third plane.

25. A device in accordance with claim 22, wherein:
said handle comprises a material that changes color depending upon certain conditions at the surface of said handle.

26. A device in accordance with claim 22, wherein:
said handle emits light.

27. A device in accordance with claim 22, wherein:
said handle comprises light emitting material.

28. A massage device comprising:
a handle of generally arcuate shape;
a plurality of flexible fingers, each of said fingers having one end affixed in said handle, each of said fingers having a first portion extending laterally and radially outward from a first end of said handle, and each of said flexible fingers having a second portion extending downward from its corresponding first portion, each of said second portions terminating in a free end, the free ends of said fingers being used to contact and apply stimulating sensations to a body portion.

29. A massage device in accordance with claim 28, wherein:
said handle comprises a first plurality of rounded over protrusions proximate one end of said handle on a first side of said handle for providing massage action separate from said flexible fingers.

30. A massage device in accordance with claim 29, wherein:
said handle comprises a second plurality of rounded over protrusions proximate the other end of said handle on said first side of said handle for providing massage action.

31. A massage device in accordance with claim 30, wherein:
said handle comprises a third plurality of rounded over protrusions carried on a surface of said handle that is substantially opposite said first protrusions.

32. A massage device in accordance with claim 28, wherein:
each of said fingers is resilient such that it corresponding free end may move to conform to the surface of the body portion contacted with the free ends.

33. A massage device in accordance with claim 28, wherein:
each of said fingers comprises copper wire.

34. A massage device in accordance with claim 33, wherein:
each said free end terminates in a smooth portion.

35. A massage device in accordance with claim 34, wherein:
each said free end terminates in a rounded portion.

36. A massage device in accordance with claim 28, wherein:
said handle has a cavity formed therein; and
each of said flexible fingers has a third portion extending from said first portion into said cavity, and each said third portion is affixed to said handle in said cavity.

37. A massage device in accordance with claim 36, comprising:
a cap disposed on said handle at said first end, said cap having an aperture through which each of said fingers extends.

38. A massage device in accordance with claim 28, comprising:
an insert extending into said handle at said first end, said insert being coupled to said fingers in said handle.

39. A massage device in accordance with claim 38, wherein:
said handle comprises a cavity; and
said insert is retained in said cavity.

40. A massage device in accordance with claim 39, wherein:
each of said flexible fingers has a third portion extending from said first portion into said insert; and
each said third portion being affixed within said insert.

41. A massage device in accordance with claim 38, wherein:
said insert and said fingers are removable as a unitary piece from said handle.

42. A massage device in accordance with claim 38, wherein:
said insert comprises a vibrator.

43. A device in accordance with claim 28, wherein:
each of said fingers first portions is disposed in substantially a first plane; and
each of said fingers second portions is disposed in substantially a second plane that intersects said first plane.

44. A device in accordance with claim 28, wherein:
each of said finger first portions is disposed in substantially a first plane; and
said finger free ends all lie in substantially a third plane.

45. A device in accordance with claim 28, wherein:
said handle comprises a material that changes color depending upon certain conditions at the surface of said handle.

46. A device in accordance with claim 28, wherein:
said handle emits light.

47. A device in accordance with claim 28, wherein:
said handle comprises light emitting material.

48. A device for providing stimulation sensations to a body portion, comprising:
a handle for gripping and manipulating said device;
a plurality of fingers extending from one end of said handle, each of said fingers having a free end and an opposite end; and
a vibrator disposed within said handle and coupled to said plurality of fingers;
each of said fingers being resilient, each of said fingers having a first portion extending from said handle and each having a second portion terminating in a corresponding free end, each said finger second portion being contiguous to and extending in a direction different from said first portion;
whereby said free ends of said fingers are used to apply pressure to and to couple vibrations from said vibrator to a body portion.

49. A device in accordance with claim 48, wherein:
each of said fingers first portions is disposed in substantially a first plane; and
each of said fingers second portions is disposed in substantially a second plane that intersects said first plane.

50. A device in accordance with claim 48, wherein:
each of said finger first portions is disposed in substantially a first plane; and
said finger free ends all lie in substantially a third plane.

51. A device in accordance with claim 48, wherein:
said handle comprises a material that changes color depending upon certain conditions at the surface of said handle.

52. A device in accordance with claim 48, wherein:
said handle emits light.

53. A device in accordance with claim 48, wherein:
said handle comprises light emitting material.

54. A massage device comprising:
a member having a plurality of fingers integrally formed therewith, said fingers being in a splayed relationship to each other and each having a first portion extending outward from a common portion and a second portion extending downward from said first portion, each of said second portions terminating in a free end, the free ends of said fingers being used to contact and apply stimulating sensations to a body portion.

55. A massage device in accordance with claim 54, comprising:
one or more vibrators carried by said member.

56. A massage device in accordance with claim 54 comprising:
a plurality of vibrator units, each of said vibrator units being carried by a corresponding one of said second portions.

57. A massage device in accordance with claim 54, comprising:
a handle adapted to removably and lockingly engage said member.

58. A massage device in accordance with claim 57, comprising:
a handle coupled to said member.

59. A massage device in accordance with claim 54, wherein:
said member comprises a plurality of depressions formed therein, each of said depressions being disposed proximate one of said corresponding second portions and each adapted to receive a fingertip.

60. A massage device in accordance with claim 54, comprising:
at least one additional member adapted to engage and be carried on by one of said second portions, said at least one additional member having an external shape different from that of said second portion.

61. A massage device in accordance with claim 54, wherein:
said member comprises a thermally responsive material.

62. A massage device in accordance with claim 54, wherein:
said member comprises a light emitting material.

63. A massage device in accordance with claim 54, wherein:
the ends of said fingers define a curve.

64. A massage device in accordance with claim 54, comprising:
a plurality of protrusions disposed on said member opposite said second portions, said plurality of protrusions being adapted to contact and apply stimulating sensations to a body portion.
